(19) United States
(12) Patent Application Publication
(10) Pub. No.: US 2012/0132093 A1
(43) Pub. Date: May 31, 2012

(54) IMAGE TRANSFER BLANKET

(76) Inventors: Annan Arraf, Ness Zion, (IL); Itzhak Ashkenazi, Kfar Gibson (IL); Wael Salalha, Bel Jan galil (IL); Meir Soria, Jerusalem (IL); Doron Avramov, Gedora (IL); Clayton Holstun, San Marcos, CA (US)

(21) Appl. No.: 13/387,411

(22) PCT Filed: Mar. 30, 2010
(86) PCT No.: PCT/US10/29231

§ 371 Date: Jan. 27, 2012

(51) Int. Cl. B41C 3/08

(52) U.S. Cl. 101/401.1

(57) ABSTRACT

An image transfer blanket usable with an image forming apparatus includes a main blanket body, a plurality of release layers configured to receive and transfer an image, each release layer disposed across from opposites sides of the main blanket body, and a plurality of soft layers configured to conform to a substrate onto which the image is transferred, each soft layer disposed between a respective release layer and the main blanket body.

### BACKGROUND

Image forming apparatuses, such as a liquid electrostatic printing apparatuses, include image transfer blankets that receive images formed by the image forming apparatuses and transfer the images onto substrates such as print media. The image transfer blankets have a limited lifespan. Specifically, the outer layers of the image transfer blanket develop permanent damage that, over time, adversely affect print quality. Accordingly, image transfer blankets are normally replaced periodically.

### BRIEF DESCRIPTION OF THE DRAWINGS

Exemplary non-limiting embodiments of the present general inventive concept are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a schematic view illustrating an image forming apparatus including an image forming blanket according to an exemplary embodiment of the present general inventive concept.

FIG. 2 is a partial side view illustrating a portion of an image transfer blanket usable with an image forming apparatus according to an exemplary embodiment of the present general inventive concept.

FIGS. 3A and 3B are partial side views illustrating a portion of image transfer blankets usable with an image forming apparatus according to exemplary embodiments of the present general inventive concept.

FIGS. 4A and 4B are partial side views of a portion of an image forming apparatus including an image transfer blanket having a normal state (FIG. 4A) and a reverse state (FIG. 4B) according to exemplary embodiments of the present general inventive concept.

### DETAILED DESCRIPTION

In the following detailed description, reference is made to the accompanying drawings which form a part hereof, and in which is depicted by way of illustration specific embodiments in which the general inventive concept may be practiced. It is to be understood that other embodiments may be utilized and structural or logical changes may be made without departing from the scope of the present general inventive concept. The following detailed description, therefore, is not to be taken in a limiting sense, and the scope of the present general inventive concept is defined by the appended claims.

Several types of conventional image transfer blankets are used in image forming apparatuses. In one type, that is, a regular blanket, the entire image transfer blanket would need to be periodically replaced. In another type, that is, a split blanket, a portion of the image transfer blanket can be replaced such as a removable top blanket independent of the rest of the image transfer blanket. In the case of the regular blanket, the entire image transfer blanket used in an image forming apparatus is normally replaced when the useful life of any part of the image transfer blanket expires. Even though, the outer layers of the image transfer blanket expire well before the inner layers of the image transfer blanket. In the case of the split blanket, a removable top blanket including outer layers of the image forming blanket can be replaced independent of the main blanket body. For example, the removable top blanket may be attached to and detached from a main blanket body of the image transfer blanket.

In accordance with the present general inventive concept, the regular blanket and the split blanket include two image receiving surfaces such as release layers to receive an image in which each image receiving surface is located across from opposite sides of the main blanket body. One image receiving surface, that is, release layer, of the image transfer blanket is positioned to receive an image, for example, from a photo imaging member (PIP) at a time. Thus, when the useful life of one of the respective release layer has expired, the image transfer blanket is reoriented to allow the other release layer to be repositioned and receive the image from the PIP. For example, a user or technician may invert the image transfer blanket, that is, turn it inside-out, with respect to the intermediate drum. Thus, the useful life of the image transfer blanket is significantly increased due to the dual image receiving surfaces of the image transfer blanket.

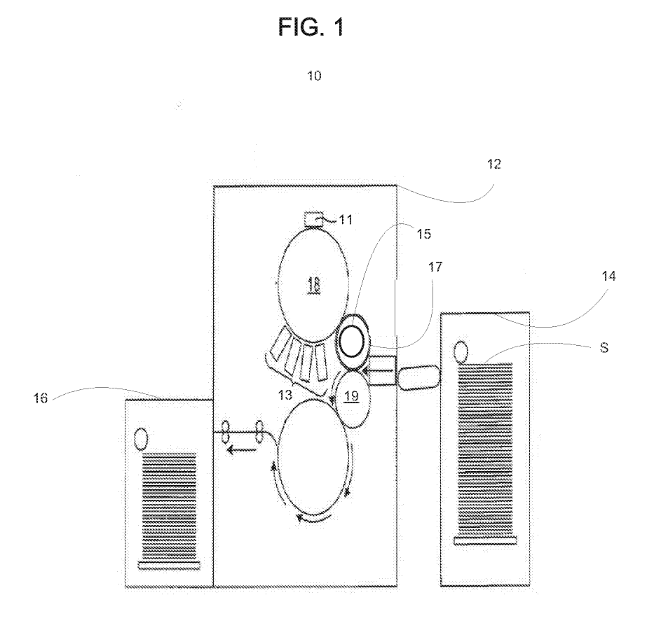

FIG. 1 is a schematic view of an embodiment of an image forming apparatus including an image forming blanket according to an exemplary embodiment of the present general inventive concept. Referring to FIG. 1, an image forming apparatus 10 includes an image forming unit 12 that receives a substrate S such as a recording media from an input unit 14 and outputs the substrate S to an output unit 16. The image forming unit 12 includes a PIP 18 that defines an outer surface on which images can be formed. For example, the outer surface can be charged with a suitable charger (not illustrated), such as a charge roller, and portions of the outer surface that correspond to features of the image can be selectively discharged by a laser writing unit 11 to form an electrostatic image on the outer surface. A fluid such as ink, or pigment contained in the ink, can then be applied to the electrostatic image with ink development units 13 such as binary ink developers to form an ink image on the outer surface. In an example, the ink may include HP ElectroInk including charged pigmented particles in a liquid carrier.

The ink image formed on the outer surface of the PIP 18 is transferred to an intermediate member such as an intermediate drum 15, which includes an image transfer blanket 17 that overlies an outer surface of the intermediate drum 15. More particularly, the image transfer blanket 17 is securely attached to the outer surface of the intermediate drum 15. The intermediate drum 15 is configured to receive the ink image from the PIP 18, heat the image, and transfer the image to the substrate S. During the transfer from the intermediate drum 15 to the substrate S, the substrate S is pinched between the intermediate drum 15 and an impression member 19. The repeated printing over time wears the outer layers of the image transfer blanket 17 of the intermediate drum 15. In some cases, even inner layers become damaged as well, through permanent deformations. Once the ink image has been transferred to the substrate 5, the substrate S can be transported to the output unit 16.

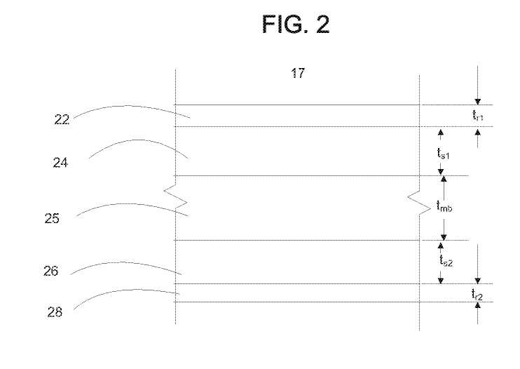

FIG. 2 is a partial side view illustrating a portion of an image transfer blanket usable with an image forming apparatus according to an exemplary embodiment of the present general inventive concept. Referring to FIG. 2, in the present example, an image transfer blanket 17a usable with an image forming apparatus 10 (FIG. 1) includes a main blanket body 25, a plurality of release layers 22 and 28 configured to receive and transfer an image in which each release layer 22 and 28 is disposed across from opposites sides of the main blanket body 25, and a plurality of soft layers 24 and 26 configured to conform to a substrate S onto which the image is transferred in which each soft layer 24 and 26 is disposed between a respective release layer 22 and 28 and the main blanket body 25. In the present example, the plurality of release layers 22 and 28 includes a first release layer 22 and a second release layer 28 and the plurality of soft layers 24 and 26 includes a first soft layer 24 and a second soft layer 26. Generally, the main blanket body 25 is robust and has a longer life than the outer layers such as the soft layers 24 and 26 and the release layers 22 and 28 in which it supports.

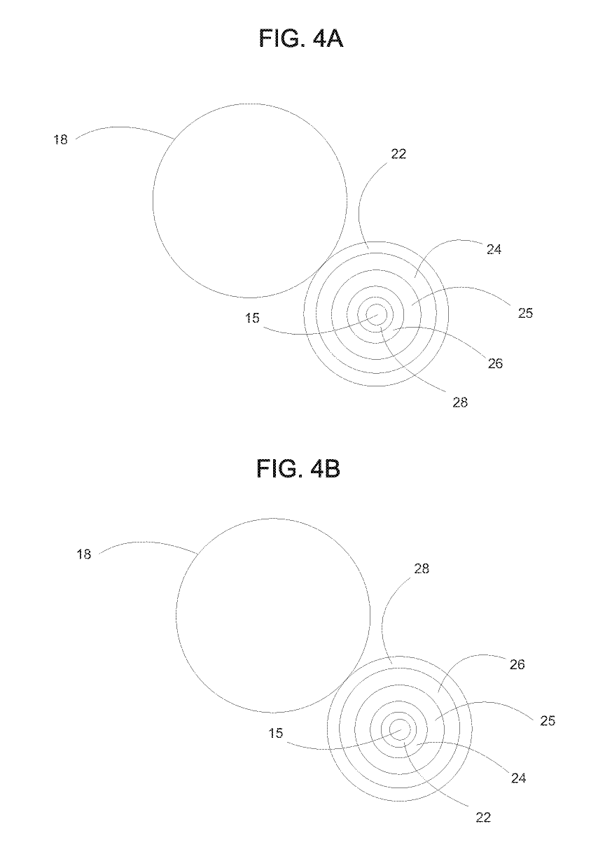

Referring to FIG. 2, in the present example, the first release layer 22 is disposed on the first soft layer 24, the first soft layer 24 is disposed on the main blanket body 25, the main blanket body 25 is disposed on the second soft layer 26, and the second soft layer 26 is disposed on the second release layer 28. In an example, the main blanket body 25 may include elastic materials and/or elastic polymers such as acrylic rubber, netryl rubber and polyurethane. A respective release layer 22 and 28 in contact with the intermediate drum 15 creates resistance therewith and prevents creeping of the image transfer blanket 17. For example, as illustrated in FIG. 4A, in a normal state, the second release layer 28 is adjacent to the intermediate drum 15 and as illustrated in FIG. 4B, in a reverse state, the first release layer 22 is adjacent to the intermediate drum 15. Also, including a first pair of a respective release layer 22 and soft layer 24 across from one side of the main blanket body 25 and a second pair of a respective release layer 28 and soft layer 26 across from the other side of the main blanket body 25 may increase conformability of the image transfer blanket 17 with respect to the substrate S onto which an image is transferred.

Referring to FIG. 2, in an example, a first release layer thickness tᵣ₁ and a second release layer thickness tᵣ₂ may be in a range of, but not limited to, 5 to 10 microns. The first and second release layer 22 and 28 may include silicone. A first soft layer thickness tₛ₁ and a second soft layer thickness tₛ₂ may be in a range of, but not limited to, 80 to 180 microns. The first and second soft layer 24 and 26 may include acrylic material. A main body blanket thickness t_{mb} may be in a range of, but not limited to, 900 to 1150 microns such as 1000 microns. The main body blanket 25 may include elastic materials and/or elastic polymers such as acrylic rubber, netryl rubber and polyurethane. In an example, the first soft layer thickness tₛ₁ and the second soft layer thickness tₛ₂ are approximately equal. In another example, the first soft layer thickness tₛ₁ and the second soft layer thickness tₛ₂ are not equal. Such unequal thickness may increase conformability of the image transfer blanket 17 to rough and untreated substrates.

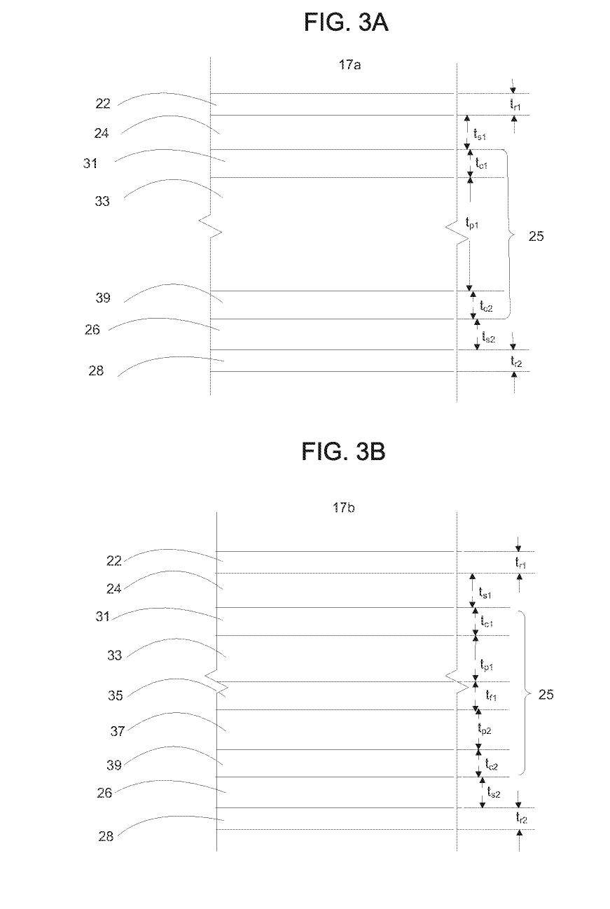

FIG. 3A is a partial side view illustrating a portion of an image transfer blanket usable with an image forming apparatus according to an exemplary embodiment of the present general inventive concept. Referring to FIG. 3A, in an example, the main blanket body 25 of an image transfer blanket 17a includes a plurality of conductive layers 31 and 39 configured to create an electrostatic field to assist image transfer. In this example, the main blanket body 25 also includes at least one compressible layer 33 configured to conform to the substrate S onto which the image is transferred. In an example, the plurality of conductive layers 31 and 39 includes a first conductive layer 31 and a second conductive layer 39. Also, the compressible layer 33 is disposed between the first conductive layer 31 and the second conductive layer 39.

Referring to FIG. 3A, in an example, the main blanket body 25 includes the first conductive layer 31 disposed on the compressible layer 33, and the compressible layer 33 disposed on the second conductive layer 39. In an example, a first conductive layer thickness t_{c1} and the second conductive layer thickness t_{c2} may be in a range of, but not limited to, 140 to 180 microns. The first and second conductive layer 31 and 39 may include cooper and aluminum. A compressible layer thickness tₚ₁ such as the first compressible layer 33 may be in a range of, but not limited to, 80 to 350 microns. The first compressible layer 33 may include acrylic material.

FIG. 3B is a partial side view illustrating a portion of an image transfer blanket usable with an image forming apparatus according to an exemplary embodiment of the present general inventive concept. Referring to FIG. 3B, in an example, the main blanket body 25 of an image forming blanket 17b includes a plurality of conductive layers 31 and 39 configured to create an electrostatic field to assist image transfer, a plurality of compressible layers 33 and 37 configured to conform to the substrate S onto which the image is transferred, and a fabric layer 35 configured to provide mechanical strength to support the plurality of compressible layers 33 and 37. In the present example, the plurality of conductive layers 31 and 39 includes a first conductive layer 31 and a second conductive layer 39. Also, the plurality of compressible layers 33 and 37 includes a first compressible layer 33 and a second compressible layer 37. In an example, the compressible layers 33 and 37 and/or the soft layers 24 and 26 are also configured to conform appropriately to the PIP 18 and impression member 19 creating correct nip size and dynamics.

Referring to FIG. 3B, in an example, the main blanket body 25 includes the first conductive layer 31 disposed on the first compressible layer 33, the first compressible layer 33 disposed on the fabric layer 35, the fabric layer 35 disposed on the second compressible layer 37, and the second compressible layer 37 disposed on the second conductive layer 39. In an example, a first compressible layer thickness tₚ₁ and the second compressible layer thickness tₚ₂ may be in a range of, but not limited to, 80 to 350 microns. The first and second compressible layer 33 and 37 may include acrylic material. A fabric layer thickness t_{f1} may be in a range of, but not limited to, 200 to 250 microns, The fabric layer 35 may include cotton fibers.

FIGS. 4A and 4B are partial side views of a portion of an image forming apparatus including an image transfer blanket having a normal state (FIG. 4A) and a reverse state (FIG. 4B) according to exemplary embodiments of the present general inventive concept. Referring to FIGS. 4A and 4B, in an example, the image forming apparatus includes a PIP 18, an intermediate drum 15, and an image transfer blanket 17 disposed on the intermediate drum 15. In this example, the image transfer blanket 17 includes a main blanket body 15, a first and a second release layer 22 and 28 configured to receive an image from the PIP 18 and transfer the image to a substrate Sin which each release layer 22 and 28 is disposed across from opposites sides of the main blanket body 25, and a plurality of soft layers 24 and 26 configured to conform to the substrate S onto which the image is transferred in which each soft layer 24 and 26 is disposed between a respective release layer 22 and 28 and the main blanket body 25. In the normal state, as illustrated in 4A, the first release layer 22 is proximate to the PIP 18 to receive the image therefrom and the second release layer 28 is proximate to the intermediate drum 15. In the reverse state, as illustrated in 4B, the second release layer 28 is proximate to the PIP 18 to receive the image therefrom and the first release layer 22 is proximate to the intermediate drum 15. In the present example, the image forming apparatus includes a liquid electrostatic printing apparatus including HP ElectroInk to form images on a recording medium such as paper.

The present general inventive concept has been described using non-limiting detailed descriptions of example embodiments thereof that are provided by way of example and are not intended to limit the scope of the general inventive concept. It should be understood that features and/or operations described with respect to one embodiment may be used with other embodiments and that not all embodiments of the general inventive concept have all of the features and/or operations illustrated in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe examples contemplated by the inventors and therefore may include structure, acts or details of structures and acts that may not be essential to the general inventive concept and which are described as examples. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. An image transfer blanket usable with an image forming apparatus, the image transfer blanket comprising:
a main blanket body;
a plurality of release layers configured to receive and transfer an image, each release layer disposed across from opposites sides of the main blanket body; and
a plurality of soft layers configured to conform to a substrate onto which the image is transferred, each soft layer disposed between a respective release layer and the main blanket body.

2. The image transfer blanket according to claim 1, wherein the plurality of release layers comprises a first release layer and a second release layer.

3. The image transfer blanket according to claim 2, wherein the plurality of soft layers comprises a first soft layer and a second soft layer.

4. The image transfer blanket according to claim 3, wherein the first release layer is disposed on the first soft layer, the first soft layer is disposed on the main blanket body, the main blanket body is disposed on the second soft layer, and the second soft layer is disposed on the second release layer.

5. The image transfer blanket according to claim 1, wherein the main blanket body comprises one of acrylic rubber, netryl rubber and polyurethane.

6. The image transfer blanket according to claim 1, wherein the main blanket body comprises a plurality of conductive layers configured to create an electrostatic field to assist image transfer and at least one compressible layer configured to conform to the substrate onto which the image is transferred.

7. The image transfer blanket according to claim 6, wherein the plurality of conductive layers comprises a first conductive layer and a second conductive layer, and the compressible layer is disposed between the first conductive layer and the second conductive layer.

8. The image transfer blanket according to claim 1, wherein the main blanket body comprises:
a plurality of conductive layers configured to create an electrostatic field to assist image transfer;
a plurality of compressible layers configured to conform to the substrate onto which the image is transferred: and
a fabric layer configured to provide mechanical strength to support the plurality of compressible layers.

9. The image transfer blanket according to claim 8, wherein the plurality of conductive layers comprises a first conductive layer and a second conductive layer, and the plurality of compressible layers include a first compressible layer and a second compressible layer.

10. The image transfer blanket according to claim 9, wherein the first conductive layer is disposed on the first compressible layer, the first compressible layer is disposed on the fabric layer, the fabric layer is disposed on the second compressible layer, and the second compressible layer is disposed on the second conductive layer.

11. The image transfer blanket according to claim 3, wherein a thickness of the first soft layer and the second soft layer are approximately equal.

12. The image transfer blanket according to claim 3, wherein a thickness of the first soft layer and the second soft layer are not equal.

13. The image transfer blanket according to claim 2, further comprising:
a normal state in which the first release layer is proximate to a photo imaging member (PIP) of the image forming apparatus and configured to receive an image therefrom and the second release layer is proximate to an intermediate drum of the image forming apparatus; and
a reverse state in which the second release layer is proximate to the PIP and configured to receive the image therefrom and the first release layer is proximate to the intermediate drum.

14. The image transfer member according to claim 2, wherein each of the first and second release layer has a thickness of approximately five microns.

15. An image forming apparatus including an image transfer blanket having a normal state and a reverse state, the apparatus comprising:
a photo imaging member (PIP):
an intermediate drum; and
an image transfer blanket disposed on the intermediate drum, the image transfer blanket comprising:
a main blanket body;
a first and a second release layer configured to receive an image from the PIP and transfer the image to a substrate, each release layer disposed across from opposites sides of the main blanket body; and
a plurality of soft layers configured to conform to the substrate onto which the image is transferred, each soft layer disposed between a respective release layer and the main blanket body;
wherein, in the normal state, the first release layer is proximate to the PIP to receive the image therefrom and the second release layer is proximate to the intermediate drum and, in the reverse state, the second release layer is proximate to the PIP to receive the image therefrom and the first release layer is proximate to the intermediate drum.
